(19) United States
(12) Patent Application Publication
(10) Pub. No.: US 2025/0303430 A1
(43) Pub. Date: Oct. 2, 2025

(54) Sprinkler With An Adjustable Pressure Regulator

(71) Applicant: Rain Bird Corporation, Azusa, CA (US)

(72) Inventors: Michael A. McAfee, Tucson, AZ (US); Mateusz Grzegorz Kruzel, Tucson, AZ (US); Arianne Madriaga Williams, Vail, AZ (US); Matthew S. Prucinsky, Vail, AZ (US); Ryan Douglas Lee, Snohomish, WA (US)

(21) Appl. No.: 18/617,199

(22) Filed: Mar. 26, 2024

(51) Int. Cl. B05B 12/08; B05B 15/74

(52) U.S. Cl. CPC B05B 12/087; B05B 15/74

(57) ABSTRACT

An irrigation device is provided having a housing with an inlet and a riser movable relative to the housing between a retracted position and an extended position. The irrigation device includes a pressure regulator mounted in the riser. The pressure regulator has a flow tube, a flow seat, and an elongated actuator. The flow tube is movable relative to the flow seat to control fluid flow into the flow tube. The elongated actuator is sized to extend through the flow tube to apply force from a nozzle assembly mounted to the riser to the flow seat to set a position of the flow seat in the riser.

### FIELD

This disclosure relates to sprinklers and, in particular, to pressure regulators for sprinklers.

### BACKGROUND

Many sprinklers have pressure regulators that limit the pressure of the water emitted from the sprinkler. Many of these pressure regulators are fixed to regulate to a predetermined pressure. Some irrigation suppliers offer a variety of sprinklers with pressure regulators fixed to different regulation pressures. For example, some sprinklers have pressure regulators configured to operate at 30 psi while other sprinklers have pressure regulators configured to operate at 45 psi. An installer may select to use either a 30-psi sprinkler or a 45-psi sprinkler based on the desired pressure. For example, many spray nozzles operate optimally at 30 psi, while many rotary nozzles operate optimally at 45 psi. If a sprinkler having a different regulation pressure is desired, the sprinkler is replaced with a sprinkler having a pressure regulator set to regulate at that desired regulation pressure. Some have developed pressure regulators that may be manually adjusted to the desired regulation pressure; however, this requires an installer to set each sprinkler to the desired regulation pressure which can be time consuming and prone to user error.

One concern in landscape irrigation is minimizing water waste. Many sprinklers are prone to water waste when the nozzle of the sprinkler is removed or damaged. For example, a user may remove the sprinkler nozzle when changing to a different nozzle or during routine maintenance and forget to attach the sprinkler nozzle. As another example, a vandal may intentionally damage the sprinkler or cause the nozzle to become partially or completely detached. The removed or damaged nozzle may not be immediately evident and may result in loss of water until the nozzle is replaced. Discharge of water without the nozzle may result in flooding or overwatering in certain areas and may also result in underwatering in other areas.

### BRIEF DESCRIPTION OF THE DRAWINGS

FIG. 1 is a perspective view of a sprinkler having an adjustable pressure regulator system and a rotary nozzle shown with a riser in a retracted position.

FIG. 2 is a cross-sectional view of the sprinkler of FIG. 1 taken along line 2-2 of FIG. 1 with the riser in the retracted position and with an adjustable flow seat of the pressure regulator system in a first position.

FIG. 3 is a cross-sectional view of the sprinkler of FIG. 1 taken similar to FIG. 2 with the riser in an extended position.

FIG. 4 is a close-up, cross-sectional view of a portion of the riser of the sprinkler of FIG. 1.

FIG. 5 is an exploded perspective view of the adjustable pressure regulator system of the sprinkler of FIG. 1.

FIG. 6 is a cross-sectional view of a valve body of the sprinkler of FIG. 1 with the flow seat in the first position.

FIG. 7 is a cross-sectional view of the valve body of FIG. 6 with the flow seat in a second position.

FIG. 8 is an exploded perspective view of the valve body of FIG. 6.

FIG. 9 is a perspective view of the sprinkler of FIG. 1 with the riser in the retracted position and with a spray nozzle instead of the rotary nozzle.

FIG. 10 is a cross-sectional view of the sprinkler of FIG. 9 taken along line 10-10 of FIG. 9, showing the riser in the retracted position and the adjustable flow seat of the pressure regulator system in the second position.

FIG. 11 is a cross-sectional view of the sprinkler of FIG. 9 taken similar to FIG. 10 with the riser in the extended position.

FIG. 12 is a cross-sectional view of the sprinkler of FIG. 1 shown with the nozzle assembly removed and in the extended position.

FIG. 13 is a cross-sectional view of a sprinkler having an adjustable pressure regulator system according to another embodiment and a rotary nozzle setting an adjustable flow seat of the adjustable pressure regulator system to a first position.

FIG. 14 is a cross-sectional view of the sprinkler of FIG. 13 with a spray nozzle instead of the rotary nozzle and the adjustable flow seat of the adjustable pressure regulator system in a second position.

FIG. 15 is a top perspective view of a float of the adjustable pressure regulator system of FIG. 13 in an assembled configuration.

FIG. 16 is a top perspective view of the float of FIG. 15 in a disassembled configuration.

FIG. 17 is a top perspective view of a valve body of the sprinkler of FIG. 13.

FIG. 18 is an exploded perspective view of the valve body of FIG. 17.

FIG. 19 is a cross-sectional view of the valve body of FIG. 17.

FIG. 20 is a top perspective view of the flow seat of the adjustable pressure regulator system of FIG. 13.

FIG. 21 is a cross-sectional view of the sprinkler of FIG. 13 shown with the nozzle assembly removed and in the extended position.

FIG. 22 is a cross-sectional view of a sprinkler according to another embodiment that has a longer sprinkler housing and a rotary nozzle setting a flow seat of an adjustable pressure regulator of the sprinkler to a first position.

FIG. 23 is a top perspective view of a float and a valve body of the adjustable pressure regulator of FIG. 22.

FIG. 24 is a cross-sectional view of the sprinkler of FIG. 22 having a spray nozzle instead of a rotary nozzle and the flow seat of the adjustable pressure regulator in a second position.

### DETAILED DESCRIPTION

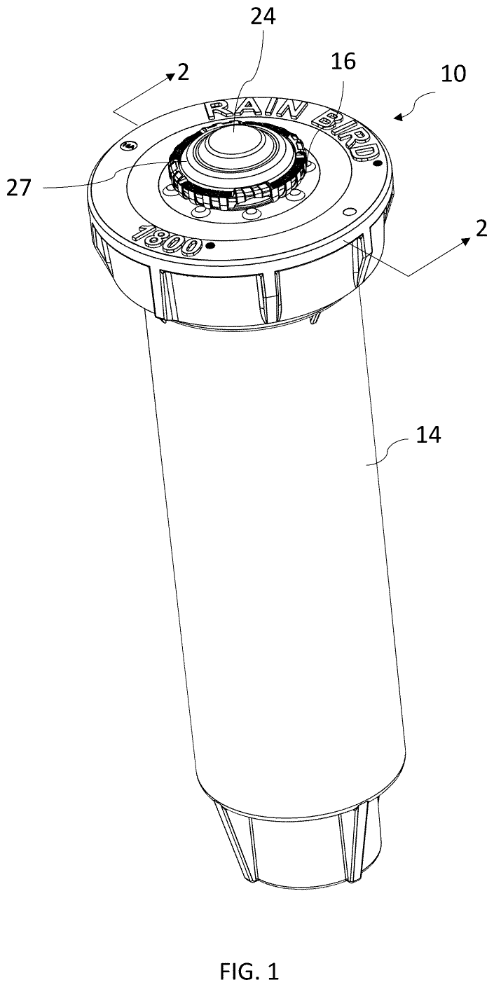

With respect to FIGS. 1-4, a sprinkler 10 with a self-adjusting pressure regulator 12 is provided. The pressure regulator 12 limits the pressure of the water emitted from the sprinkler 10 so that the emitted water pressure does not exceed a set regulation pressure. The pressure regulator 12 is adjustable to increase and/or decrease the regulation pressure. The regulation pressure of the pressure regulator 12 is automatically set based on the nozzle assembly attached to the sprinkler 10 as discussed below. The regulation pressure of the pressure regulator 12 may be adjustable in a certain range of pressures, e.g., 35 psi to 45 psi. In other examples, however, the pressure regulator 12 may be adjustable within a different range of regulation pressures.

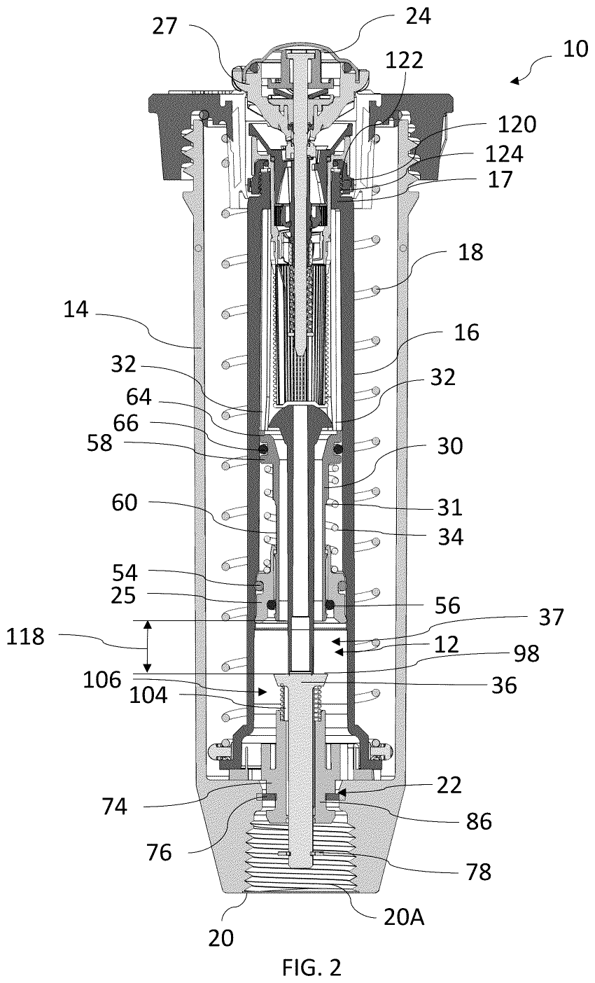

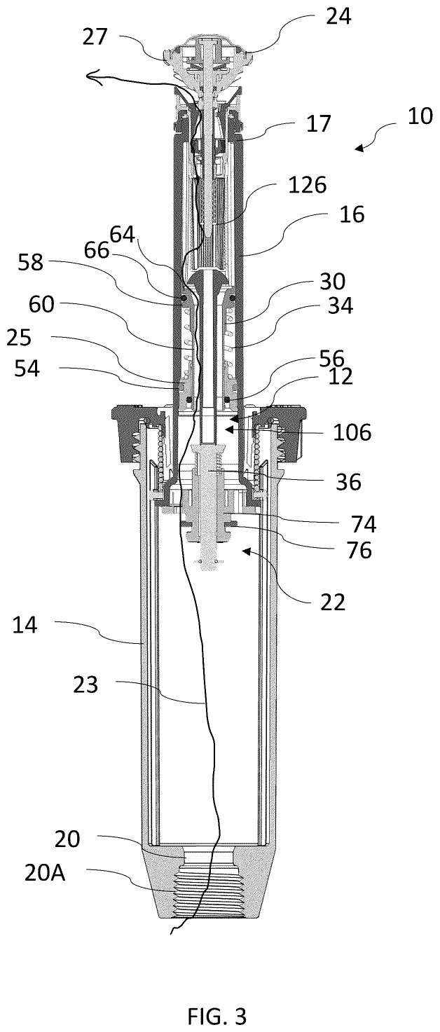

In the example illustrated, the sprinkler 10 is a pop-up sprinkler that includes a stationary housing 14 and a riser 16 that reciprocates in (see FIG. 2) and out (see FIG. 3) of the housing 14. In the form shown, the sprinkler 10 may have a pop-up height of about four inches although, as discussed below, sprinklers of other sizes may be similarly used. The sprinkler 10 has a spring 18 that retracts the riser 16 into the housing 14 between irrigation cycles. The housing 14 includes an inlet 20 that is connectable to irrigation conduit connected to a water source. The inlet 20 may have threads 20A such that the inlet 20 may be threaded to a connector of an irrigation system. During an irrigation cycle, water flows into the inlet 20 of the sprinkler 10, and the water pressure forces the riser 16 to move upward relative to the housing 14 to the extended position (shown in FIG. 3) against the bias of the spring 18. Water flows along flow path 23 (see FIG. 3) through the inlet 20, around a valve body 22 of the riser 16, through the pressure regulator 12, and out of the sprinkler 10 through an outlet, such as nozzle assembly 24, at an upper end of the riser 16. The spring 18 forces the riser 16 to return to its retracted position when the bias force of the spring 18 overcomes the force of the water on the riser 16 (e.g., when the water supply is turned off). The spring 18 forces the valve body 22 to seat in the inlet 20 to close the inlet 20 between irrigation cycles as discussed below.

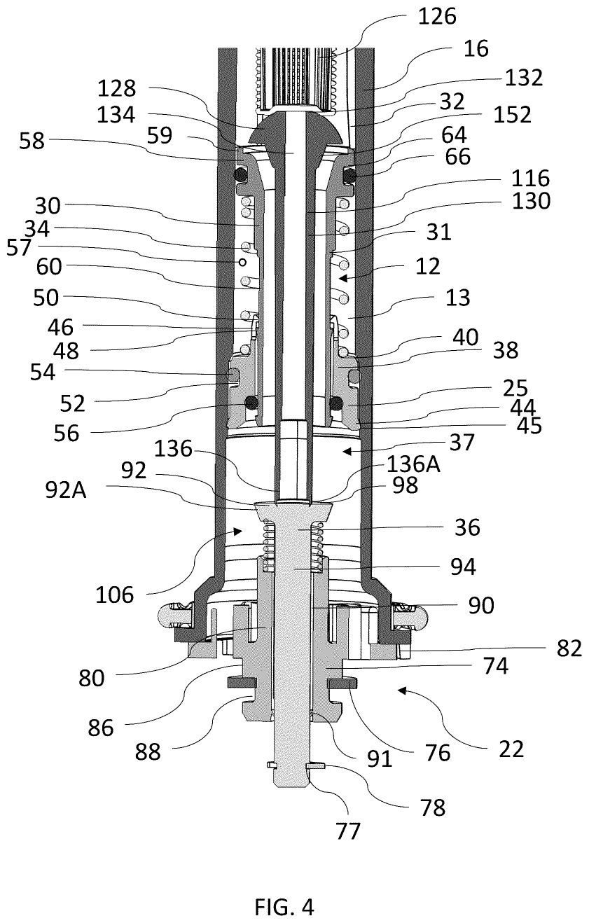

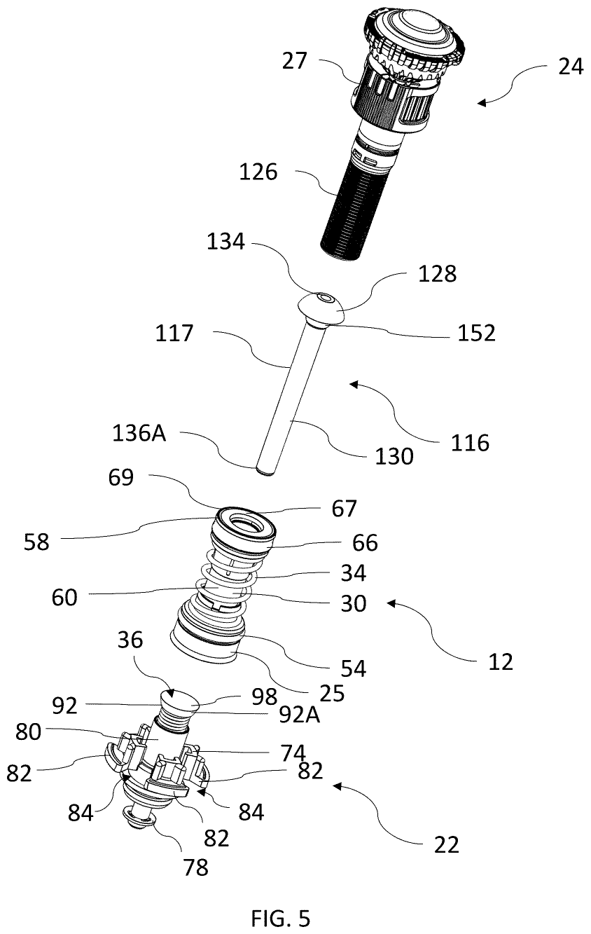

With respect to FIGS. 4-5, the pressure regulator 12 includes a retainer 25, a flow tube 30, a spring 34, a flow seat 36, and an elongated actuator such as float 116. The retainer 25 is secured to the riser 16. The flow tube 30 moves toward and/or away from the flow seat 36 to regulate the pressure of the water emitted from the sprinkler 10. The riser 16 includes one or more internal ribs 32 that serve as a stop to limit the movement of the flow tube 30 away from the flow seat 36. The spring 34 extends between the retainer 25 and an upper flange 58 of the flow tube 30 to bias the flow tube 30 downstream toward the internal ribs 32 and away from the flow seat 36 to a resting position. As water pressure downstream of the flow tube 30 increases, the water pressure applies a force to the flow tube 30, for example, at the upper flange 58, which may force the flow tube 30 to move toward the flow seat 36 against the bias of the spring 34. As the flow tube 30 moves toward the flow seat 36, an annular gap 37 between the flow seat 36 (e.g., a periphery of the flow seat 36) and the end of the flow tube 30 decreases. Decreasing the gap 37 between the flow tube 30 and the flow seat 36 constricts the flow area which results in an increase in the pressure drop of the water as the water enters the flow tube 30. In other words, decreasing the gap 37 restricts the amount of water able to flow into the flow tube 30, which reduces the pressure on the water emitted from the sprinkler 10 downstream of the flow tube 30 (e.g., at the nozzle assembly 24). As the flow tube 30 moves away from the seat 36 (when the bias force of the spring 34 exceeds the force of the water pressure on the flow tube 30), the annular gap 37 between the flow tube 30 and the seat 36 enlarges which increases the pressure of the water emitted from the sprinkler 10. This ensures that the water pressure at the nozzle is proper and optimized for the nozzle so that the proper amount of water discharges from the nozzle. Too much pressure can, for example, cause the water to mist, which affects the travel distance of the water, and results in overwatering.

With reference to FIG. 4, the retainer 25 includes an annular body 38 received in the riser 16 through which the flow tube 30 extends. The inner surface of the riser 16 includes an annular step 40 limiting axial movement of the retainer 25 in the downstream direction. The retainer 25 includes an annular protrusion 44 that may be received in an annular recess 45 of the riser 16 to secure the retainer 25 in the riser 16 and inhibit the retainer 25 from axial movement in the upstream direction.

The retainer 25 may have retention arms 46 that extend along the flow tube 30 to limit axial movement of the flow tube 30 in the downstream direction (e.g., due to the bias of spring 34). The retention arms 46 may be annular or partially annular to extend about the circumference of the flow tube 30. The retention arms 46 have hooks 50 that contact an annular protrusion 48 of the flow tube 30 when the flow tube 30 is moved downstream. The hooks 50 limit how far the flow tube 30 can move downstream relative to the retainer 25.

The retainer 25 may also serve as a stop to limit movement of the flow tube 30 in the upstream direction. For example, the hooks 50 may contact a shoulder 31 of the flow tube 30 when the flow tube 30 moves upstream. The shoulder 31 is sized such that it is not able to pass through the opening defined by hooks 50, for example, having a larger diameter than the opening defined by the hooks 50. The hooks 50 may also help guide the flow tube 30 as it travels within the riser 16.

The retainer 25 further includes an annular recess 52 that receives a seal 54, such as an O-ring. The seal 54 extends from the retainer 25 to the inner surface of the riser 16 to form a fluid tight connection that prevents water from flowing between the retainer 25 and the riser 16.

The pressure regulator 12 may further include a seal 56, such as an O-ring, positioned between an inside surface of the retainer 25 and the flow tube 30. The seal 56 may form a fluid tight connection between the retainer 25 and the flow tube 30 as the flow tube 30 moves relative to the retainer 25 to prevent water from flowing between the retainer 25 and the flow tube 30.

The flow tube 30 has an upper flange 58 and a tube portion 60 extending from the upper flange 58 and defining a portion of the fluid flow path 23. The spring 34 may contact the upper flange 58 to bias the flow tube 30 downstream. The upper flange 58 includes an annular recess 64 receiving a seal 66, such as an O-ring. The seal 66 extends between the flow tube 30 and the interior surface of the riser 16 forming a fluid tight connection therebetween as the flow tube 30 moves relative to the riser 16. The seals 54, 56 of the retainer 25 and the seal 66 of the flow tube 30 form an air chamber 13 between the upper flange 58 of the flow tube 30 and the retainer 25. The riser 16 includes a vent 57 (see FIG. 4) to the ambient which permits air to flow into and out of the air chamber 13 keep the air chamber 13 at atmospheric pressure during a watering cycle. The seals 54, 56, and 66 ensure that the air chamber 13 remains at atmospheric pressure regardless of the water pressure in the riser 16 which permits the flow tube 30 to move toward the flow seat 36 as the downstream pressure increases.

The flow tube 30 may include a debris ring 59 (see FIG. 4) extending downstream from the upper flange 58. The debris ring 59 may direct debris falling upstream to pass through the flow tube 30 and inhibit the debris from passing between the flow tube 30 and the riser 16.

With respect also to FIGS. 5-8, the inlet valve body 22 includes a body 74, a seal 76, the flow seat 36, and a clip 78. The body 74 is separated and spaced apart from the retainer 25 by an axial gap 106 (see FIG. 4). The body 74 has a central portion 80 and attachment arms 82 extending radially outward from the central portion 80. The attachment arms 82 may be connected to an end portion of the riser 16 to attach the inlet valve body 22 to the riser 16. For example, the attachment arms 82 may be welded to the end portion of the riser 16 (e.g., by sonic welding). The body 74 includes gaps 84 between the attachment arms 82 through which water can flow into the riser 16 when the inlet valve body 22 is moved from the inlet 20.

The lower end 86 (see FIG. 4) of the central portion 80 of the body 74 below the attachment arms 82 includes an annular recess 88 that may receive the seal 76 (e.g., a washer seal) in applications where it is desired to close the inlet 20, for example, between irrigation cycles. The lower end 86 of the central portion 80 may be sized to be removably inserted into the inlet 20 of the sprinkler housing 14 to close and open the inlet 20 of the sprinkler 10 as the riser 16 moves between the extended and retracted configurations. As shown in FIG. 2, when the riser 16 is in the retracted configuration, the lower end 86 of the central portion 80 of the inlet valve body 22 is inserted into the inlet 20 of the housing 14. The seal 76 extends from the body 74 to the wall of the housing 14 defining the inlet 20 to seal the inlet 20. The seal 76 may inhibit water from flowing out of the sprinkler 10 when the water pressure upstream of the sprinkler 10 is low and not high enough to overcome the biasing force of the spring 18 of the riser 16. When the water pressure increases (e.g., during an irrigation cycle), the force of the water pressure on the inlet valve body 22 overcomes the biasing force of the spring 18, moving the riser 16 toward the extended configuration shown in FIG. 3. When in the extended configuration, the lower end 86 of the body 74 and the seal 76 are moved upward and out of the inlet 20 of the housing 14 permitting water to flow through the inlet 20 and out of the sprinkler 10.

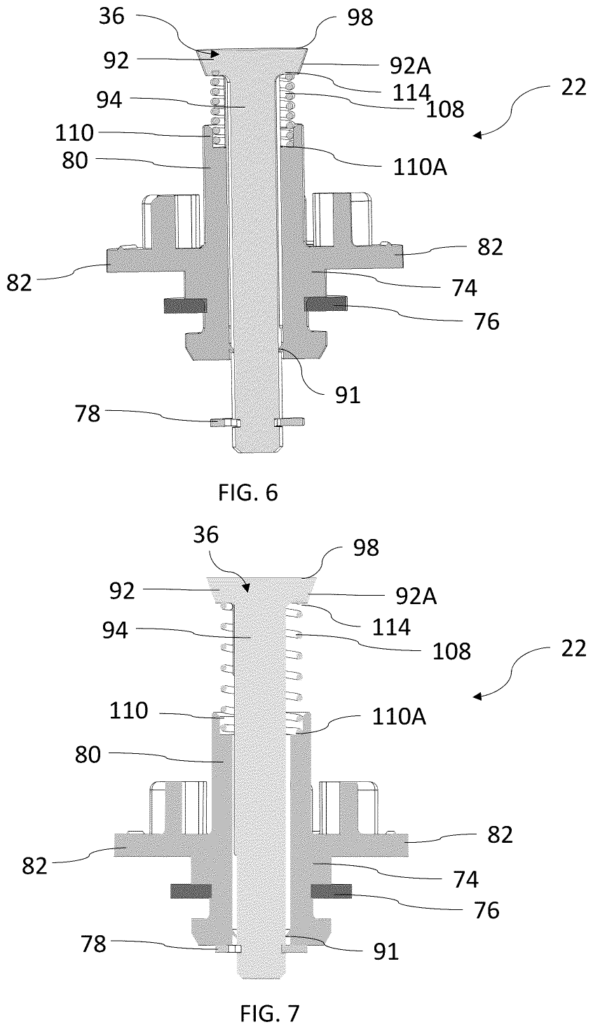

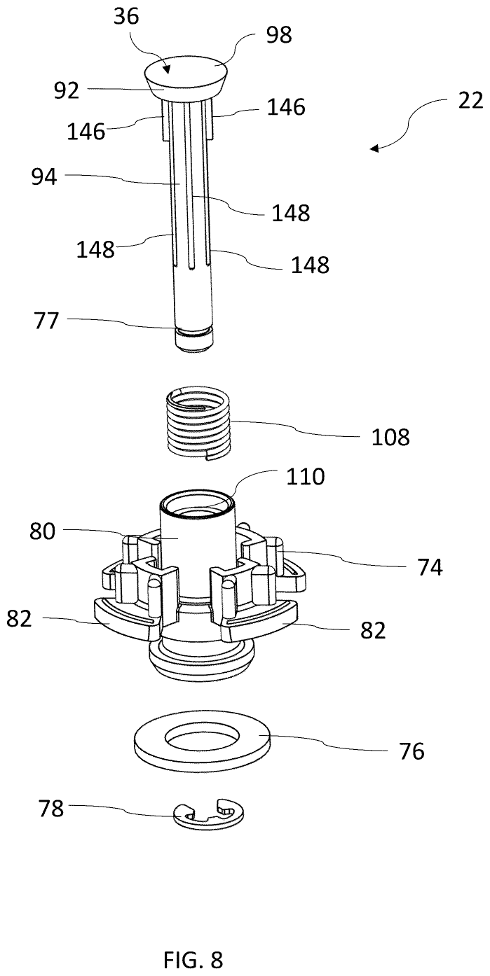

The central portion 80 of the body 74 defines a cylindrical passage 90 for receiving the flow seat 36. The flow seat 36 includes a disc or enlarged head 92 and a shaft 94 extending from the head 92. The shaft 94 is sized to be inserted through the passage 90 of the body 74. The body 74 may include an annular seal 91 (see FIG. 6) in the cylindrical passage 90 to engage the shaft 94. The seal 91 inhibits fluid from entering the sprinkler 10 between the shaft 94 and the body 74 while permitting the shaft 94 to move in the cylindrical passage 90. The clip 78 may be attached to the shaft 94 of the flow seat 36 upon being extended through the body 74. The clip 78 may be snapped on to an annular groove 77 (see FIG. 8) formed in the shaft 94. The portion of the shaft 94 with the groove 77 extends out from the body 74. The clip 78 extends radially outward from the shaft 94 and is sized such that the clip 78 is not able to pass into the passage 90 of the body 74. The clip 78 thus limits how far the seat 36 can move axially toward the flow tube 30 upon contacting the surface of the body 74 about the passage 90 (see FIG. 7).

The shaft 94 supports the head 92 of the seat 36 away from the body 74 in the axial gap 106 between the retainer 25 and the body 74. For example, the head 92 may be spaced apart from the body 74 a distance in the range of about 2 mm to about 15 mm. As one specific example, the head 92 is spaced about 7.6 mm from the body 74. A biasing member such as a spring 108 urges the head 92 of the flow seat 36 from the body 74 toward the flow tube 30. In the form shown, the spring 108 is a coil spring, however, in other embodiments other types of springs may be used. The shaft 94 of the seat 36 extends through the coils of the spring 108. One end of the spring 108 may contact the body 74 while the other end contacts the flow seat 36 (e.g., the head 92) to urge the head 92 from the body 74. The body 74 may include an annular socket 110 at an inboard end of the passage 90 of the body 74 that receives one end of the spring 108. The socket 110 limits movement of the spring 108 relative to the body 74 (e.g., radial movement). The spring 108 may contact the upstream side 114 of the head 92 of the flow seat 36 to urge the head 92 downstream and toward the flow tube 30.

With the head 92 of the flow seat 36 being positioned in the axial gap 106, there is no structure radially outward of the head 92 of the flow seat 36 between the head 92 and the inner surface of the riser 16. The axial gap 106 provides a space between the body 74 and the retainer 25 where the water flowing into the riser 16 may flood and pool before flowing through the flow tube 30. Moreover, with no structure around the head 92 of the flow seat 36, there is no structure that obstructs or restricts the flow of water as it flows around the head 92 and to the flow tube 30, which minimizes the turbulence in the flow to the flow tube 30. In the form shown, the entire annular outer edge 92A of the head 92 is exposed to water flow and guides the waterflow around the head 92 toward the flow tube 30. The annular outer edge 92A of the head 92 may be frustoconical to aid in guiding the flow of water around and past the head 92.

With respect to FIG. 8, the flow seat 36 may include one or more elongated stop protrusions 146 that extend radially outward from the shaft 94 below the head 92. The stop protrusions 146 may be radially larger than at least a portion of the passage 90 of the body 74 and, thus, limit how far the flow seat 36 is able to move axially toward the body 74 because the stop protrusions 146 will eventually contact the surface of the body 74 about the passage 90 (see FIG. 4). For example, the stop protrusions 146 may be sized such that they engage a bottom 110A of the socket 110 to limit movement of the head 92 of the flow seat 36 toward the body 74. The stop protrusions 146 may be positioned to ensure that the head 92 of the flow seat 36 remains spaced from the body 74 and positioned within the axial gap 106 to minimize turbulence in the flow. The stop protrusions 146 may be positioned to inhibit movement of the flow seat 36 when the spring 108 is fully compressed to prevent the spring 108 from being over compressed. The stop protrusions 146 may extend axially along the shaft 94 from the head 92 of the flow seat 36.

The flow seat 36 may include ribs 148 that extend axially along the shaft 94 from the head 92. The ribs 148 may reduce the frictional engagement between the shaft 94 and the passage 90 of the body 74 to facilitate movement of the flow seat 36 relative to the body 74 of the inlet valve body 22. The ribs 148 may also provide space between shaft 94 and the body 74 to receive debris that enters the passage 90. Providing space to receive debris inhibits the debris from getting wedged between the shaft 94 and the body 74 which may inhibit movement of the shaft 94 relative to the body 74. The ribs 148 may terminate above the seal 91 of the inlet valve body 22 such that the ribs 148 do not pass beyond the seal 91 when the flow seat 36 is moved to its upstream position. This prevents leaks at the sealing engagement between the shaft 94 and the body 74.

The head 92 of the flow seat 36 includes a floor 98 that the flow tube 30 moves relative to responsive to downstream water pressure as described above. During operation of the sprinkler 10, the axial position of the floor 98 is substantially fixed in the riser 16. Movement of the flow tube 30 relative to the floor 98 regulates the pressure of the water emitted from the sprinkler 10. Before operation of the sprinkler 10, the floor 98 may be moved axially in the riser 16 to a desired axial position to set the regulation pressure of the sprinkler 10, such as the maximum pressure of the fluid downstream of the flow tube 30. The axial position of the floor 98 may be adjusted by applying a force to the seat 36 to overcome the biasing force of the spring 108 to move the head 92 toward the body 74. The axial position of the head 92 may also be adjusted by removing force from the seat 36 permitting the biasing force of the spring 108 to urge the head 92 from the body 74. The axial position of the floor 98 sets the maximum distance between the floor 98 and the flow tube 30, for instance, when the flow tube 30 is in its downstream resting position (e.g., with no downstream water pressure). The maximum distance between the floor 98 and the flow tube 30 adjusts the pressure in and downstream of the flow tube 30 and thus the pressure of the water emitted from the sprinkler 10. As the maximum distance between the floor 98 and the flow tube 30 is increased, the maximum pressure of the sprinkler 10 at the nozzle assembly is increased because the flow tube 30 must travel farther to reach the floor 98 of the flow seat 36 to restrict the flow of fluid through the flow tube 30. Because the flow tube 30 must travel farther to reach the floor 98, the force of the water pressure on the flow tube 30 must be greater to compress the spring 34 the increased distance.

The position of the floor 98 in the riser 16 may be set by the nozzle assembly attached to the riser 16. The position to which the floor 98 is set by the nozzle assembly may be based on the type of nozzle assembly attached to the riser 16. For instance, certain types of nozzles such as rotary nozzles (e.g., multi-stream rotary variable arc nozzles) operate optimally at a higher pressure (e.g., 45 psi), while other types of nozzles such as spray nozzles (e.g., variable arc nozzles, high efficiency variable arc nozzles, matched precipitation rate nozzles) operate optimally at a lower pressure (e.g., 30 psi). The position of the floor 98 in the riser 16 may thus be set based on whether the nozzle is a higher-pressure nozzle type or a lower-pressure nozzle type.

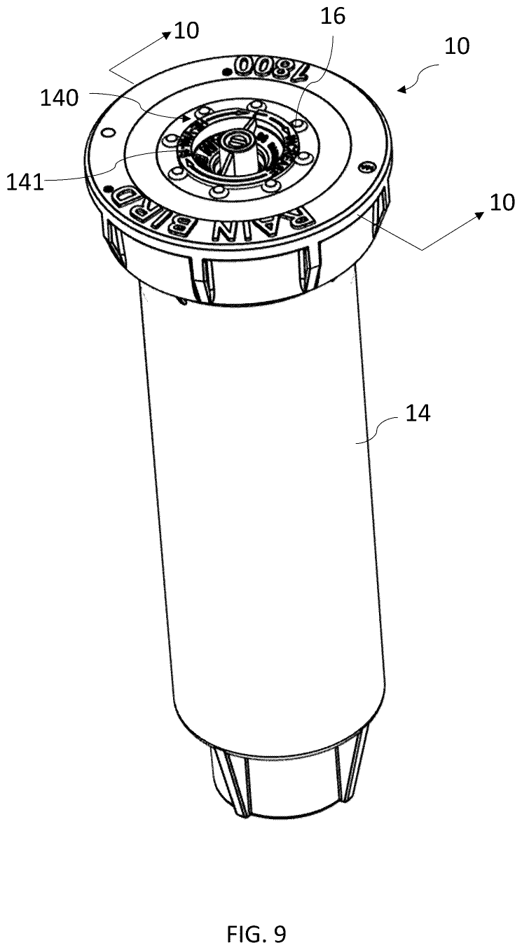

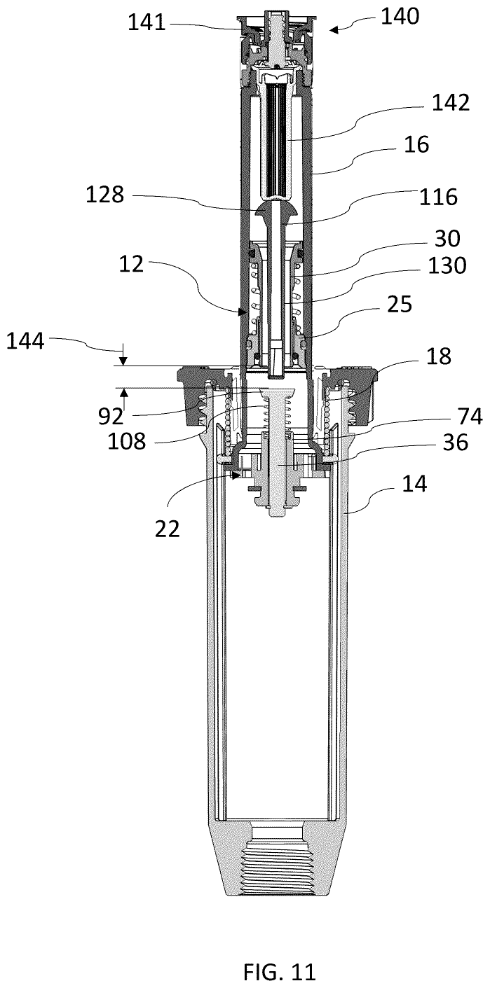

In FIGS. 1-4, the nozzle assembly 24 attached to the riser 16 of the sprinkler 10 includes a rotary nozzle 27 that operates optimally at 45 psi. In FIGS. 9-11, the nozzle assembly 140 attached to the riser 16 of the sprinkler 10 includes a spray nozzle 141 that operates optimally at 30 psi. The pressure regulator 12 includes a float 116 that extends between the nozzle assembly of the sprinkler 10 and the flow seat 36. The float 116 may move the seat 36 axially based on the distance the nozzle assembly extends into the riser 16.

With reference to FIGS. 1-4, the nozzle assembly 24 presses the float 116 against the flow seat 36 to set the axial position of the flow seat 36 relative to the riser 16. The nozzle assembly 24, which includes the higher-pressure rotary nozzle 27, is sized to set the seat 36 to a higher regulation pressure position. In the higher regulation pressure position, the flow seat 36 is urged upstream toward the body 74 against the biasing force of the spring 108 and spaced a distance 118 (see FIG. 2) apart from the flow tube 30 in its resting position. As shown in FIG. 2, the nozzle assembly 24 is secured to the riser 16 which presses the float 116 upstream and against the seat 36, compressing the spring 108. The nozzle assembly 24 may be secured to the riser 16 by threading the nozzle assembly 24 to the end of the riser 16. For example, the nozzle assembly 24 has an attachment portion 120 with threads 122 that engage threads 124 at the outlet 17 of the riser 16 (see FIG. 2).

The nozzle assembly 24 includes a filter 126 that extends into the riser 16 when attached thereto to contact the float 116. The axial length that the filter 126 extends into the riser 16 corresponds to the optimal regulation pressure for the nozzle assembly 24. For example, nozzle assembly 24 includes the rotary nozzle 27 that operates optimally at about 45 psi. Thus, the axial length the filter 126 extends into the riser 16 is a distance to press the float 116 against the flow seat 36 to the higher regulation pressure position that sets the regulation pressure of the pressure regulator 12 to about 45 psi. Attachment of the nozzle assembly 24 to the riser 16 thus automatically sets the regulation pressure for the sprinkler 10. For instance, as the nozzle assembly 24 is threaded to the riser 16, the filter 126 presses the float 116 against the flow seat 36 causing the flow seat 36 to move to the higher regulation pressure position shown, for example, in FIG. 2.

With reference to FIGS. 4 and 5, the float 116 includes an elongated body 117 having a head 128 and a shaft 130 extending from the head 128. The head 128 of the float 116 may be dome-shaped or hemispherical. The shape of the head 128 may correspond to the shape of a bottom 132 of the filter 126 of the nozzle assembly 24 against which the head 128 seats when the nozzle assembly 24 is attached to the riser 16. The bottom 132 of the filter 126 may have a recess (e.g., a dome-shaped recess) to receive a portion of the float 116 to inhibit the head 128 from shifting relative to the filter 126 as fluid flows through the riser 16. The head 128 and shaft 130 may define a passage 134, that extends longitudinally through the float 116, for example, along the entire length of the float 116.

As shown in FIG. 4, the shaft 130 is sized for loose-fit reception within the flow tube 30 of the pressure regulator 12. The shaft 130 may have a narrow cross-section to minimize restriction of fluid flow through the flow tube 30. The end portion 136 of the shaft 130 opposite the head 128 engages the floor 98 of the seat 36. The maximum outer diameter of head 128 may be smaller than the internal diameter of the riser 16 to allow fluid to flow about the outside of the float 116 during irrigation. The float 116 may have a length sized to extend between the nozzle assembly 24 and the flow seat 36. The length of the float 116 may be selected based on the size of the sprinkler. In the sprinkler 10 shown in FIGS. 1-4, the float 116 may have a length of about 51 mm. The end portion 136 may have a deformable segment 136A that deforms (e.g., compresses) when the end portion 136 is forced against the flow seat 36. For example, the deformable segment 136A may be thin (e.g., have reduced thickness relative to the remainder of the shaft 130) such that the deformable segment 136A compresses (e.g., bends or crumples) when the float 116 is urged against the flow seat 36. Permitting the deformable segment 136A to compress axially reduces the overall length of the float 116 to ensure the nozzle assembly 24 is able to be fully attached to the riser 16 regardless of minor size variations of the sprinkler 10 components from manufacturing tolerances.

The float 116 may also include a tapered portion 152 (see FIG. 4) at the transition between the head 128 and the shaft 130. The tapered portion 152 may taper radially outward as the tapered portion 152 extends from the shaft 130 to the head 128. The tapered portion 152 may aid to direct fluid flow radially outward and around the head 128. The tapered portion 152 may thus reduce turbulence in the fluid flow relative to a sharp transition between the shaft 130 and the head 128.

With respect to FIGS. 9-11, the sprinkler 10 is shown with the lower-pressure nozzle assembly 140 secured to the riser 16 in place of the higher-pressure nozzle assembly 24. The nozzle assembly 140 may be threaded to the riser 16 similar to the higher-pressure nozzle assembly 24 discussed above. In the example shown, the nozzle assembly 140 shown is a spray nozzle 141; however, other types of lower-pressure nozzle assemblies could be used as well. As shown, the spray nozzle assembly 140 includes a filter 142 that extends into the riser 16 a shorter distance than the filter 126 of the higher-pressure nozzle assembly 24 discussed above. The axial length that the filter 142 extends into the riser 16 corresponds to the optimal regulation pressure for the spray nozzle 141. For example, the spray nozzle 141 operates optimally at about 30-psi. In the form shown, the shorter filter 142 is not long enough to press the float 116 against the flow seat 36. The flow seat 36 thus remains at the lower regulation pressure position to which it is biased by the spring 108. In some forms, the lower pressure nozzle assembly 140 presses the float 116 against the seat 36 but does not move the seat 36 as far upstream as the higher-pressure nozzle assembly 24. Sizing the filter 142 and/or the float 116 such that the float 116 presses against the flow seat 36 even with the lower pressure nozzle assembly 140 may be advantageous to hold the end portion 136 of the float 116 from shifting in the riser 16 as fluid flows therethrough. In the lower regulation pressure position, the flow seat 36 is spaced a distance 144 apart from the flow tube 30 in its resting position, which is less than the distance 118 (see FIG. 2) between the flow seat 36 and flow tube 30 with the flow seat 36 in the higher regulation pressure position. Thus, in the lower regulation pressure position, annular gap 37 between the flow seat 36 and the flow tube 30 is smaller which reduces the amount of water able to flow into the flow tube 30 and reduces the distance the flow tube 30 travels before reaching the flow seat 36. The smaller annular gap 37 thus reduces the regulation pressure of the pressure regulator 12.

The distance the flow seat 36 is spaced from the flow tube 30 when in its resting position is set to control the regulation pressure of the sprinkler 10. This distance may be set using the float 116 as discussed above to position the flow seat 36 based on the type of nozzle assembly attached to the riser 16. The further the flow tube 30 can move from its resting position toward the flow seat 30, the greater the regulation pressure of the sprinkler 10 because the downstream water pressure must exert a greater force on the flow tube 30 to compress the spring 34 the increased distance and against the progressively increasing force of the spring 34. When selecting the resting distance of the flow seat 36 from the flow tube (D_{FS}) the following relation may be used:

F_{spring}=k*((L_{SF}−L_{SI})+D_{FS})=A*P_{regulation}

where F_{spring} is the force of the spring 34, k is the spring constant of the spring 34, L_{SF} is the free or uncompressed length of the spring 34, L_{SI} is the length of the spring 34 when installed (e.g., slightly compressed), A is the area 67 of the downstream end 69 of the flow tube 30 that is exposed to the downstream water pressure (see FIG. 5), and P_{regulation} is the desired regulation pressure of the sprinkler 10 (e.g., 30 psi or 45 psi). In other words, the distance D_{FS} the flow seat 36 should be moved from the flow tube 30 to achieve a desired regulation pressure P_{regulation} can be calculated using the desired regulation pressure P_{regulation}, spring constant k, the uncompressed length L_{SF} of the spring 34, the length L_{SI} of the spring 34 when installed, and the downstream area A of the flow tube 30. The length of the float 116 may thus be selected to position the flow seat 36 at a position corresponding to the desired regulation pressure P_{regulation} when the nozzle assembly is attached to the riser 16.

As an example, in the sprinkler 10, the spring constant k of the spring 34 is about 13.15 lb/in, the uncompressed length L_{SF} of the spring 34 is 1.063, the length L_{SI} of the spring 34 when installed is 0.82, and the area A of the downstream end 69 of the flow tube 30 is about 0.184 in². For a regulation pressure (P_{regulation}) of 45 psi, the resting distance of the flow seat (D_{FS}) may be set to 0.387 inches as calculated using the above relation. For a regulation pressure (P_{regulation}) of 30 psi, the resting distance of the flow seat (D_{FS}) may be set to 0.177 inches as calculated using the above relation.

While nozzle assemblies of two different optimal regulation pressures have been discussed, it should be appreciated that nozzle assemblies with other optimal regulation pressures could similarly be used to set the regulation pressure of the sprinkler 10 to the desired pressure. For instance, the length that the filter of a nozzle assembly extends into the riser 16 may be selected such that the filter urges the flow seat 36 to the desired position in the riser 16 (via the float 116) to set the pressure regulator 12 to a desired regulation pressure within the range of regulation pressures of the pressure regulator 12. For example, different nozzle assemblies may be sized to set the position the flow seat 36 to a position to set the regulation pressure to, for example, 30 psi, 34 psi, 38 psi, 42 psi, or 45 psi.

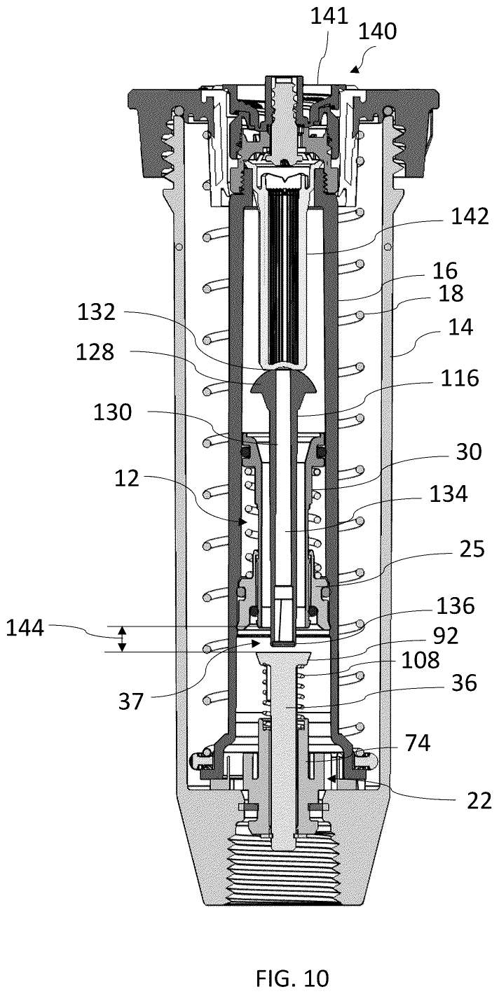

The position of the flow seat 36 in the riser 16 may be adjustable between upper and lower axial limits which set the upper and lower limits of the range of regulation pressure of the pressure regulator 12. As discussed above, the flow seat 36 may carry stop features that limit the axial movement of the flow seat 36 relative to the body 74. The stop protrusions 104 of the flow seat 36 inhibit the seat 36 from moving axially away from the flow tube 30 upon the stop protrusions 104 contacting the body 74 (see FIG. 6). The clip 78 inhibits the flow seat 36 from moving axially toward the flow tube 30 upon the clip 78 contacting the body 74 (see FIG. 7). As one example, the maximum pressure of the sprinkler 10 may be adjustable between 30 psi and 45 psi. For example, when the floor 98 of the flow seat 36 is distance 118 (see FIG. 2) from the flow tube 30, the pressure regulator 12 limits the pressure of the water emitted from the sprinkler 10 to 45 psi. When the flow seat 36 moved to position the floor 98 distance 144 (see FIG. 10) from the flow tube 30, the pressure regulator 12 limits the pressure of the water emitted from the sprinkler 10 to 30 psi. The regulation pressure may be adjusted continuously as the position of the floor 98 travels between the upper and lower limits to set the regulation pressure of sprinkler 10. In other forms, the range of regulation pressures the adjustable pressure regulator 12 may be set at is larger or smaller. In other forms, the range of pressures is different (e.g., 50 psi to 100 psi).

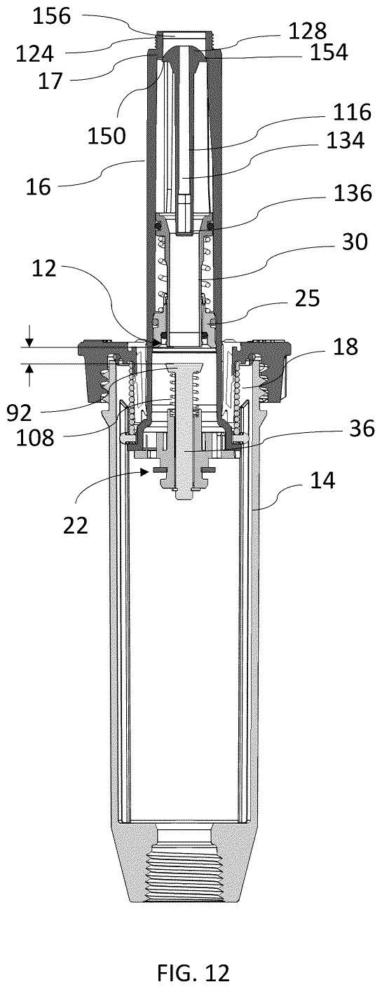

FIG. 12 shows the sprinkler 10 in operation when the nozzle assembly is absent from the sprinkler 10. The nozzle assembly may be removed from the sprinkler 10, for example, when the nozzle assembly is being changed or the sprinkler 10 has been vandalized or damaged. With the nozzle assembly removed, the float 116 can move axially upward in the riser 16 to the riser outlet 17. When the sprinkler 10 is operating, fluid flows through the flow tube 30 and applies an upward force against the head 128 of the float 116 causing the float 116 to move upwardly to the riser outlet 17 as shown in FIG. 12. The head 128 extends radially outward of the shaft 130 of the float 116 which provides a surface 150 that fluid flowing through the sprinkler 10 presses against to force the float 116 upward in the riser 16. In the form shown, the surface 150 is flat and substantially perpendicular to the flow of fluid through the riser 16 which may facilitate an upward application of force by the fluid to the float 116.

The outer dimension of the head 128 of the float 116 may be larger than the opening 156 at the riser outlet 17 which prevents the float 116 from exiting the riser 16 through the riser outlet 17. For example, the riser outlet 17 may include a transition, such as step 154, that decreases the size of the opening 156 at the riser outlet 17. The head 128 of the float 116 engages the step 154 to close the opening of the riser outlet 17 and block fluid flow therethrough. The float 116 may, however, permit a smaller volume of water to flow through the flow passage 134 and out of the riser 16. Due to the reduced cross-section of the flow passage 134 relative to the opening 156 of the riser outlet 17, fluid is ejected from the sprinkler 10 in a narrow, high velocity stream. The stream ejected from the float 116 may serve as a water “flag” to alert individuals that the sprinkler 10 does not have a nozzle assembly.

The float 116 thus decreases the amount of water that would otherwise be wasted prior to re-installation of the nozzle assembly. For example, the float 116 decreases the quantity of water that is exiting the sprinkler 10. The float 116 also provides a signal to individuals that the sprinkler needs to be repaired which may prompt repair sooner than otherwise might have been done.

The float 116 may be designed to have different desired dimensions based on various design considerations. For example, the diameter of the flow passage 134 may be selected to balance design considerations, including reducing water loss for water exiting the sprinkler 10 without the nozzle assembly and providing a volume of water sufficient to ensure a tall noticeable stream of signaling water when the nozzle assembly is removed. In the example embodiments provided, the flow passage 134 has a diameter in the range of about 0.125 inch to about 0.188 inch, which reduces the volume of discharged water on the order of about 50-70%, while ejecting a 10-15 foot tall stream of water during signaling. In other forms, the diameter of the flow passage and other dimensions of the float 116 may be designed to reduce the amount of discharged water a different desired percentage.

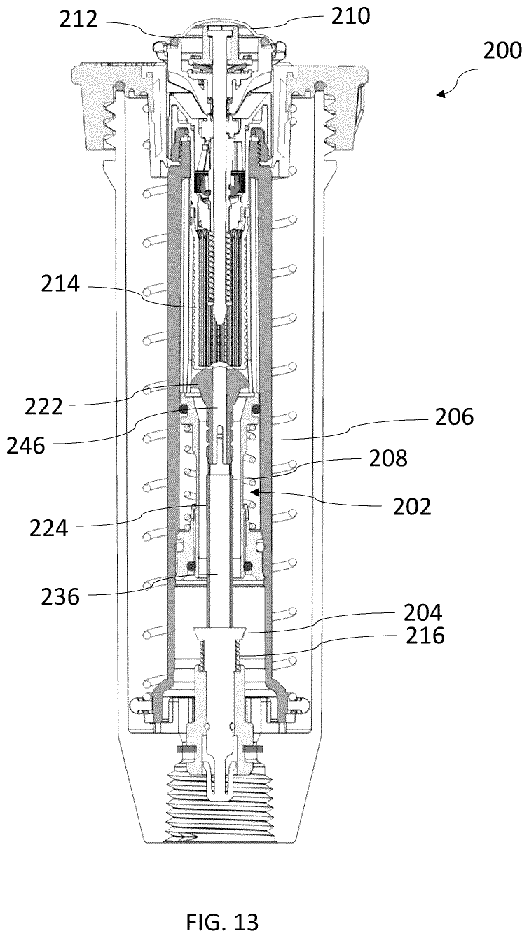

With respect to FIG. 13, a sprinkler 200 is provided having an adjustable pressure regulator 202 according to another embodiment. The adjustable pressure regulator 202 is similar in many respects to the embodiments discussed above such that the differences will be highlighted. The adjustable pressure regulator 202 may similarly be used to set the position of a flow seat 204 of the adjustable pressure regulator 202 based on the type of nozzle assembly 210 attached to the riser 206 of the sprinkler 200. For example, a float 208 of the adjustable pressure regulator 202 may contact the nozzle assembly and be urged by the nozzle assembly against the flow seat 204 to adjust the position of the flow seat 204.

The nozzle assembly 210 includes a rotary nozzle 212 and a filter 214. The filter 214 extends into the riser 206 to contact the float 208 to urge the flow seat 204 to a first position against the biasing force of a biasing member, such as a spring 216, of the adjustable pressure regulator 202. In FIG. 14, the nozzle assembly 211 includes a spray nozzle 218 and a filter 220. The filter 220 extends into the riser 206 but not as far as the filter 214 associated with the rotary nozzle 212 of FIG. 13. The spray nozzle 218 and filter 220 do not urge the float 208 against the flow seat 204 and permit the flow seat 204 to be in its second position due to the biasing force of the spring 216. In other forms, the spray nozzle 218 and filter 220 of the nozzle assembly 211 contact the float 208 to urge the float 208 against the flow seat 204 to a second position (e.g., slightly compressing spring 216), but do not move the flow seat 204 as far as the nozzle assembly 210 including the rotary nozzle 212.

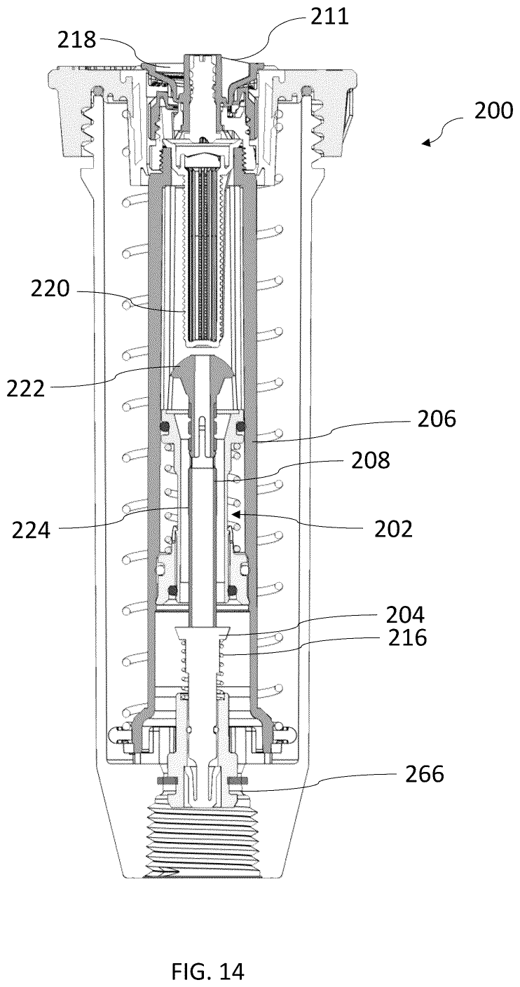

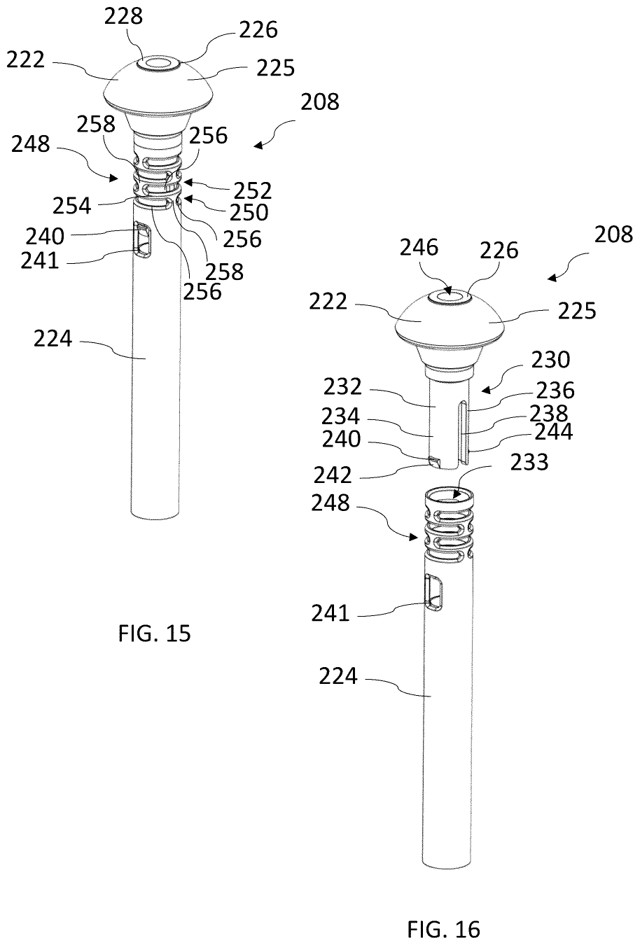

With respect to FIGS. 15 and 16, the float 208 includes a head 222 that is separable from a shaft 224. The head 222 has a main body 225 that may be hemispherical or dome-shaped. An end of the main body 225 includes an annular lip 226 that engages the bottom of the filter. The annular lip 226 may have an engagement surface 228 that is flat to contact a flat portion of the bottom of the filter. The flat engagement surface 228 of the float 208 stabilizes the interface of the float 208 with the filter and inhibits the float 208 from shifting relative to the filter during operation of the sprinkler 200 (e.g., pivoting about or toggling on the dome-shaped main body 225).

The head 222 includes a connector 230 extending from the head 222 to releasably connect the head 222 to the shaft 224. The connector 230 has a shaft portion 232 sized to be inserted into a passageway 233 of the shaft 224 of the float 208. The shaft portion 232 includes a first deflectable arm 234 and a second deflectable arm 236 separated by a slit or gap 238. The gap 238 extends axially along the shaft portion 232 from the end opposite the head 222 toward the head 222. The first deflectable arm 234 includes a protrusion 240 extending radially outward to hook an opening 241 of the shaft 224 when the connector 230 is inserted into the shaft 224. The protrusion 240 may include a ramped surface 242 that causes the first deflectable arm 234 to deflect inward from its resting configuration (e.g., into the gap 238) as the ramped surface 242 is inserted into the shaft 224. When the protrusion 240 is aligned with the opening 241 of the shaft 224, the first deflectable arm 234 elastically returns to its resting configuration urging the protrusion 240 outward and into the opening 241 to inhibit the shaft portion 232 from being withdrawn. The second deflectable arm 236 similarly includes a protrusion 244 that may be similarly received in another opening of the shaft 224 to connect the head 222 to the shaft 224. The head 222 may be disconnected from the shaft 224 by urging the protrusions 240, 244 of the first and second deflectable arms 234, 236 inward and out of the corresponding openings of the shaft 224 to permit the head 222 to be withdrawn from the shaft 224.

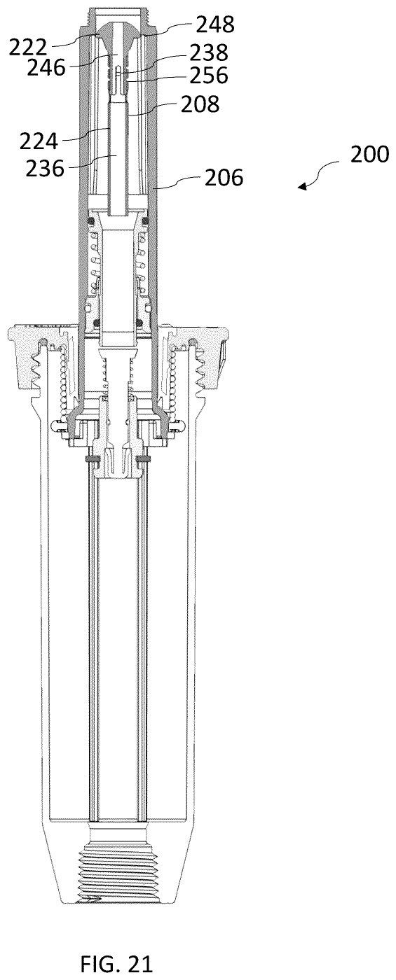

The head 222 has a passageway 246 that is connected to the passageway 233 of the shaft 224 when the head 222 is secured to the shaft 224. This permits fluid to flow through the passageways 233, 246 of the float 208 and out the head 222, for example, when the float 208 is moved upward to the outlet 17 of the riser 206 when the sprinkler 200 lacks a nozzle assembly as shown in FIG. 21.

The shaft 224 may further include one or more windows 248 to permit fluid to flow into and out of the passageways 246, 233 of the float 208 through a sidewall of the shaft 224. The windows 248 may also permit the shaft 224 to act as a spring and to be compressed axially, for example, to reduce the overall length of the float 208 to ensure the nozzle assembly 210 is able to be fully attached to the riser 206 regardless of minor size variations of the sprinkler 200 components from manufacturing tolerances. The windows 248 also may cause the float 208 to provide preload between the nozzle assembly 210 and the flow seat 204. For example, the preload provided by the float 208 may further ensure the flow seat 204 is fully moved to the higher-pressure position when higher-pressure nozzle assemblies are attached to the riser 206.

The one or more windows 248 may be positioned at an end of the shaft 224 to which the head 222 connects. In the form shown, the one or more windows 248 includes a pattern of openings separated by structural members to provide a large area of openings for fluid to flow therethrough while maintaining the shape and rigidity of the shaft 224. The windows may include a first set 250 of openings disposed circumferentially about the shaft 224 at a first axial position, a second set 252 of openings disposed circumferentially about the shaft 224 at a second axial position, and so on. With the openings disposed circumferentially about the shaft 224, at least a portion of the openings align with the gap 238 to permit fluid to flow therethrough. The sets of openings may be axially spaced apart by a structural member 254. In the form shown, each set of openings includes two arcuate openings 256 opposite one another and spaced apart by two structural members 258. The adjacent set(s) of openings may be rotated (e.g., by 90 degrees) such that the structural members 258 are misaligned to maintain the structural integrity of the shaft 224 and to facilitate axial compression rather than bending of the shaft 224 when compressed. The shaft portion 232 of the head 222 of the float 208 may also extend along the windows 248 to inhibit the shaft 224 from bending under compression and guide the shaft 224 in compressing axially. The openings 241 of the shaft 224 that receive the protrusions 240, 244 of the head 222 may be oversized to likewise permit fluid to flow into and out of the passageways 233, 246 of the float 208 through a sidewall of the shaft 224.

With respect to FIG. 21, permitting fluid to flow into the passageways 233, 246 of the float 208 through the sidewall of the shaft 224 permits fluid outward of the float 208 to flow into the float 208 and out of the sprinkler 200 through the head 222. Permitting fluid to flow into the float 208 at the outlet end of the float 208 ensures that a sufficient volume of fluid is emitted from the float 208 at a sufficient pressure to create the water flag. Without openings at the downstream end of the float 208, the pressure of the fluid flowing in the float 208 may drop as the fluid flows along the length of the float 208, particularly where the float 208 is long and/or the passageways 233, 246 narrow.

By making the head 222 separable from the shaft 224, the head 222 is able to be connected to different length shafts 224 to form a float 208 having a desired length, e.g., based on the sprinkler size. The head 222 may be made using one mold and attached to a shaft 224 having a desired length.

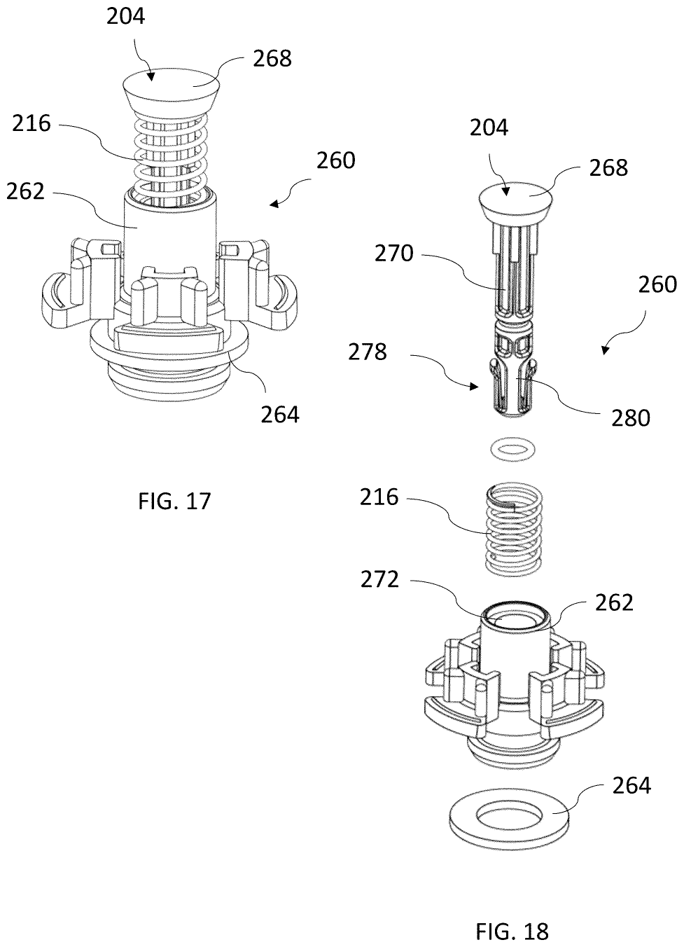

With respect to FIGS. 17-19, a valve body 260 of the sprinkler 200 is provided that is similar in many respects to the inlet valve body 22 discussed above such that the differences are highlighted. The valve body 260 includes a main body 262 mounted to the riser 206. The main body 262 supports a seal 264 to close an inlet 266 of the sprinkler 200 when in the riser 206 is in a retracted configuration. The valve body 260 may open the inlet 266 upon being removed from the inlet 266 when the riser 206 is moved to the extended configuration to permit fluid to flow through the sprinkler 200.

The flow seat 204 is mounted to the main body 262 of the valve body 260. The flow seat 204 includes a head 268 and a shaft 270 extending from the head 268. The flow tube of the pressure regulator 202 moves relative to the head 268 to control the pressure of fluid downstream of the pressure regulator 202. The flow seat 204 is movable axially in a passage 272 of the main body 262 of the valve body 260. The spring 216 may bias the head 268 toward the flow tube of the pressure regulator 202. The position of the flow seat 204 relative to the main body 262, and thus its position in the riser 206, may be adjusted by forcing the float 208 against the flow seat 204, e.g., when attaching a nozzle assembly to the riser.

With reference also to FIG. 20, the shaft 270 of the flow seat 204 includes stop ribs 274 to limit axial movement of the flow seat 204 upstream and away from the flow tube of the pressure regulator 202. The stop ribs 274 may be on a downstream end 276 of the shaft 270 adjacent to the head 268. The shaft 270 further includes a connector 278 on an upstream end 280 of the shaft 270. The connector 278 secures the flow seat 204 to the main body 262 to inhibit the flow seat 204 from unintentionally separating from the main body 262. The connector 278 may also limit axial movement of the flow seat 204 downstream and toward the flow tube of the pressure regulator 202.

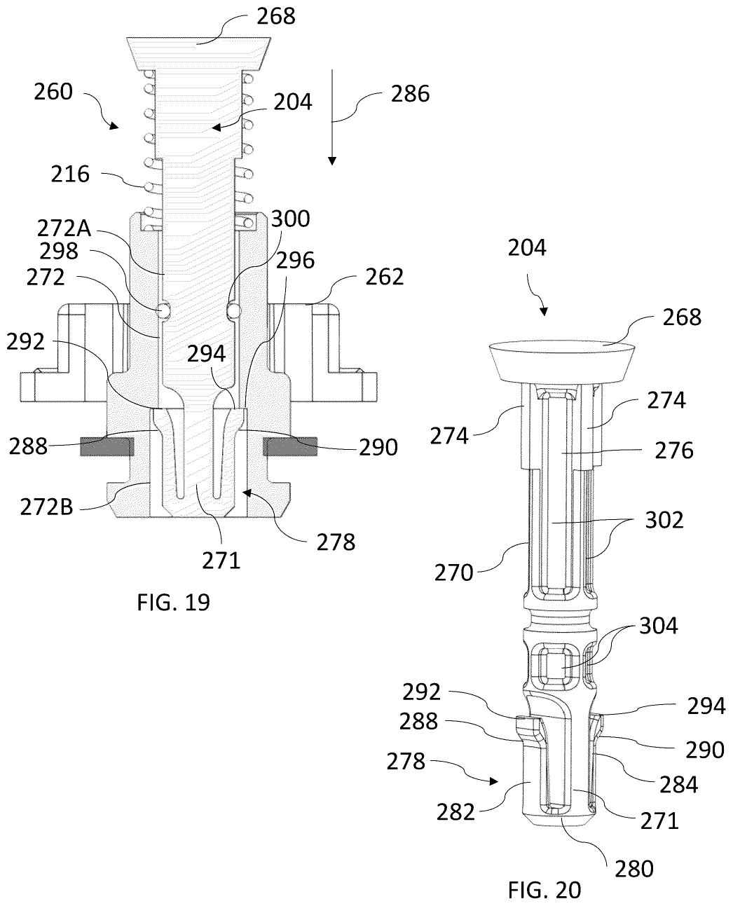

In the form shown, the connector 278 includes deflectable arms 282, 284 that are able to be deflected inward from their original, resting position. The shaft 270 includes a core 271 from which the deflectable arms 282, 284 extend. The arms 282, 284 may extend from the core 271 back toward the head 268 and along the core 271. The deflectable arms 282, 284 each include an angled surface 288, 290 and a hooking surface 292, 294. To secure the flow seat 204 to the main body 262, the connector 278 is inserted into the downstream end of the passage 272 of the main body 262 in direction 286 (see FIG. 19). The passage 272 has a smaller dimension segment 272A at the downstream end of the passage 272. Upon insertion, the angled surfaces 288, 290 of the deflectable arms 282, 284 contact the main body 262 about the passage 272, which causes the arms 282, 284 to deflect inward. The flow seat 204 may be inserted through the passage 272 until the arms 282, 284 pass a step 296 of the passage 272 to a larger dimension segment 272B of the passage 272 where a dimension (e.g., a diameter) of the passage 272 increases. Upon passing into the larger dimension segment 272B, the arms 282, 284 spring back toward their original, resting configuration as shown in FIG. 19. In the outward configuration, the hooking surfaces 292, 294 extend outward of the smaller dimension segment 272A of the passage 272 and inhibit the connector 278 from passing back through the passage 272. The spring 216 urges the flow seat 204 downstream and may urge the hooking surfaces 292, 294 into contact with the step 296. The hooking surfaces 292, 294 may contact the step 296 of the passage 272 to limit axial movement of the flow seat 204 downstream relative to the main body 262.

The shaft 270 of the flow seat 204 may support a seal, such as an O-ring 298, to inhibit fluid from flowing through the passage 272 of the valve body 260. The O-ring 298 may extend between an outer surface of the shaft 270 of the flow seat 204 and an inner surface of the main body 262 forming the passage 272. The O-ring 298 may permit the flow seat 204 to move axially along the passage 272 while maintaining a fluid tight seal with the main body 260. The shaft 270 may include an annular groove 300 extending about the circumference of the shaft 270 sized to receive the O-ring 298 therein and to fix the O-ring 298 to the flow seat 204.

The shaft 270 may include one or more recesses or pockets 302 extending axially along the shaft 270 between the head 268 and the annular groove 300. The shaft 270 may include one or more recesses or pockets 304 between the annular groove 300 and the connector 278. The pockets 302, 304 permit the shaft 270 to continue to slide within the passage 272 of the valve body 260 even when debris enters the passage 272. For example, the pockets 302, 304 provide a space to receive the debris that enters the passage 272 to inhibit the debris from getting wedged between the flow seat 204 and the main body 262 of the valve body 260 which could inhibit movement of the flow seat 204 in the main body 262. Forming the pockets 302, 304 in the shaft 270 also reduces the amount of material used to make the flow seat 204 and may inhibit the flow seat 204 from warping when molded.

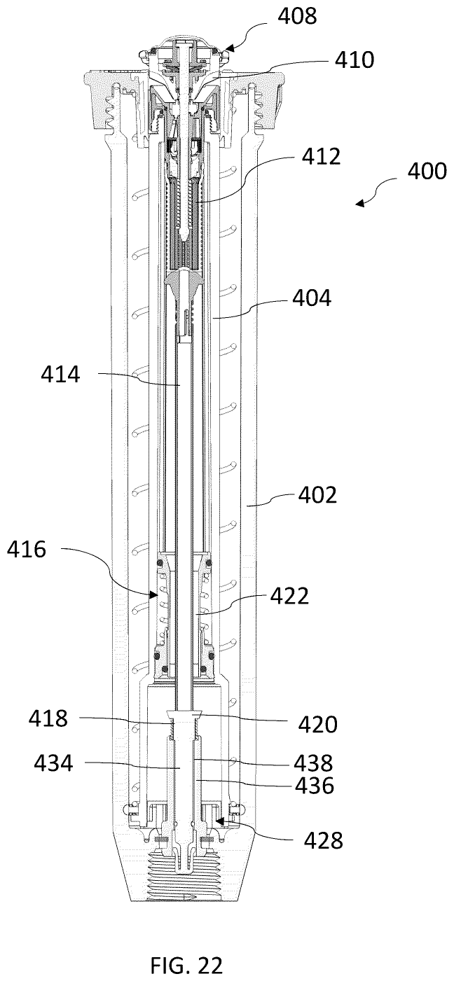

With respect to FIGS. 22-24, the adjustable pressure regulator system described herein may be adapted for use with sprinklers of different sizes. Regarding FIG. 22, a pop-up sprinkler 400 is provided that includes a housing 402 and a riser 404 like the sprinklers discussed above. The sprinkler 400, however, has a longer housing 402 and riser 404 to provide a pop-up height of about six inches, which is greater than the sprinklers discussed above. While the following discussion describes use of the adjustable pressure regulator system of this disclosure with a larger sized sprinkler, those having ordinary skill in the art will readily appreciate that the adjustable pressure regulator system may be similarly adapted for use with other size sprinklers.

In FIG. 22, the sprinkler 400 has nozzle assembly 408 attached to the riser 404 that includes a rotary nozzle 410 and filter 412. The nozzle assembly 408 may be a higher-pressure nozzle assembly that operates optimally at high pressure, e.g., 45 psi. The filter 412 contacts a float 414 of an adjustable pressure regulator 416 of the sprinkler 400. The filter 412 presses the float 414 against a flow seat 418 of the pressure regulator 416 to hold the flow seat in the higher regulation pressure position (e.g., 45 psi). Because the riser 404 of the sprinkler 400 is longer than the embodiments discussed above, the length of the float 414 may be longer to extend between the filter 412 and the flow seat 418 to move the flow seat 418 to the higher pressure position when the nozzle assembly 408 is attached. The float 414 of the sprinkler 400 may, for example, have a length of about five inches.

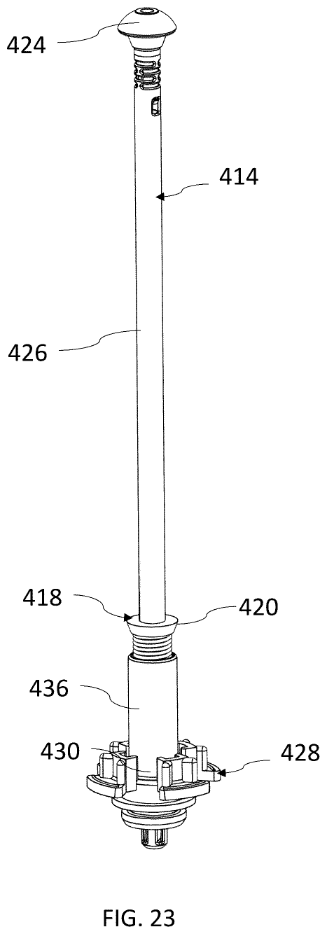

With reference to FIG. 23, the float 414 may include a head 424 and a shaft 426. The shaft 426 is longer than the shaft 224 of the float 208 discussed above to extend between the filter 412 and the flow seat 418 of the larger sprinkler 400. The head 424 may be the same as the head 222 of the float 208 discussed above and removably attachable to different length shafts (e.g., shaft 224, shaft 426) to create a float with an appropriate length for use with sprinklers of different sizes. The length of the float for the adjustable pressure regulator system of this disclosure may thus be selected based on the size of the sprinkler.

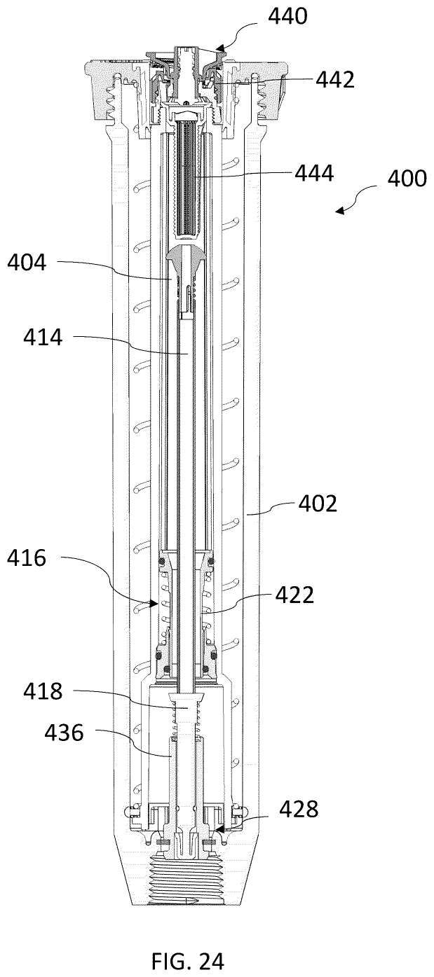

The sprinkler 400 may include a valve body 428 having a main body 430 to which the flow seat 418 is movably mounted as discussed above. In sprinkler 400, the flow seat 418 may be longer to support a head 420 of the flow seat 418 at the lower regulation pressure position (e.g., 30 psi) relative to a flow tube 422 of the pressure regulator 416 when no force is applied to the flow seat 418 (see FIG. 24). For example, the length of a shaft portion 434 of the flow seat 418 may be increased. The length of the flow seat 418 may thus be selected based on the size of the sprinkler. The main body 430 of the valve body 428 may include a central portion 436 that defines the passage 438 through which the flow seat 418 extends. The length of the central portion 436 may also be increased to extend along the increased length of the flow seat 418, for example, to aid in holding the flow seat 418 in alignment with the riser 404.

In FIG. 24, the sprinkler 400 has nozzle assembly 440 attached to the riser 404 that includes a spray nozzle 442 and filter 444. The nozzle assembly 440 may be a lower pressure nozzle assembly that operates optimally at a low pressure, e.g., 30 psi. The filter 444 extends into the riser 404 but does not extend as far into the riser as the filter 412 of the high-pressure nozzle assembly 408. The filter 444 thus does not press the float 414 against the flow seat 418 or does not press the flow seat 418 as far as higher-pressure nozzle assemblies to position the flow seat 418 in a lower regulation pressure position (e.g., 30 psi). The length of the float 414 is thus sized to adjust the position of the flow seat 418 of the sprinkler 400 based on the type of nozzle assembly attached to the riser 404 and the length of the sprinkler 400.

While the above description describes use of the adjustable pressure regulator system with pop-up sprinklers, those having skill in the art will readily appreciate that the adjustable pressure regulator may be used with other types of sprinklers with the flow seat adjustably mounted in the sprinkler such that attachment of a nozzle assembly sets the regulation pressure of the sprinkler.

The matter set forth in the foregoing description and accompanying drawings is offered by way of example and illustration only and not as a limitation. While certain embodiments have been shown and described, it will be apparent to those skilled in the art that additions, changes, and modifications may be made without departing from the broader aspects of the technological contribution. The actual scope of the protection sought is intended to be defined in the following claims.

What is claimed is:

1. An irrigation device comprising:
a housing having an inlet;
a riser movable relative to the housing between a retracted position and an extended position;
a pressure regulator mounted in the riser, the pressure regulator having a flow tube, a flow seat, and an elongated actuator;
the flow tube movable relative to the flow seat to control fluid flow into the flow tube; and
the elongated actuator sized to extend through the flow tube to apply force from a nozzle assembly mounted to the riser to the flow seat to set a position of the flow seat in the riser relative to the pressure regulator.

2. The irrigation device of claim 1 wherein the flow seat is movable axially in the riser to set a maximum pressure for fluid flowing beyond the flow tube.

3. The irrigation device of claim 2 wherein a spring urges the flow tube from the flow seat to counter fluid pressure downstream of the flow tube,
wherein the flow seat is positioned a distance D_{F}S from the flow tube by the elongated actuator to set the maximum pressure, where D_{FS}=(A*P_{Regulation})/k−(L_{SF}—L_{SI}) where A is the downstream area A of the flow tube exposed to the downstream fluid pressure, P_{regulation} is the maximum pressure, k is the spring constant of the spring, L_{SF} is an uncompressed length of the spring, and L_{SI} is an installed length of the spring.

4. The irrigation device of claim 1 further comprising a biasing member urging the flow seat axially toward the flow tube.

5. The irrigation device of claim 4 wherein the elongated actuator applies a first force to the flow seat counter to a second force of the biasing member.

6. The irrigation device of claim 1 further comprising a valve coupled to the riser, the valve closing the inlet of the housing when the riser is in the retracted position, the flow seat movably mounted to the valve.

7. The irrigation device of claim 6 wherein the flow seat includes a head and a shaft extending from the head to the valve.

8. The irrigation device of claim 7 wherein the valve defines a passage, the passage receives at least a portion of the shaft of the flow seat, and the shaft being moveable axially along the passage.

9. The irrigation device of claim 7 wherein the shaft of the flow seat extends through a passage defined by the valve, and further comprising a stop on the shaft to limit axial movement of the flow seat relative to the valve.

10. The irrigation device of claim 6 further comprising a biasing member extending between the valve and a portion of the flow seat to bias the portion of the flow seat from the valve.

11. The irrigation device of claim 1 wherein the elongated actuator includes a head and a shaft extending from the head, and the shaft of the elongated actuator sized to extend through the flow tube to the flow seat.

12. The irrigation device of claim 11 wherein the head of the elongated actuator is releasably attachable to the shaft.

13. The irrigation device of claim 1 wherein the elongated actuator is movable in the riser such that fluid pressure moves the elongated actuator to restrict fluid flow out of the riser when the riser is disconnected from a nozzle assembly.

14. The irrigation device of claim 13 wherein the elongated actuator defines a passage to emit fluid from the riser to when the riser is disconnected from the nozzle.

15. The irrigation device of claim 1 further comprising a nozzle assembly mountable to the riser, and the nozzle assembly includes a filter extending into the riser to contact the elongated actuator.

16. The irrigation device of claim 15 wherein a distance the filter extends into the riser sets the position of the flow seat via the elongated actuator.

17. The irrigation device of claim 1 wherein the elongated actuator includes a head and a shaft, the head having a connector to attach the head to the shaft.

18. The irrigation device of claim 17 wherein the connector of the head includes an attachment arm to snap into a receiver of the shaft to attach the head to the shaft.

19. An irrigation device comprising:
a housing having an inlet;
a riser movable relative to the housing between a retracted position and an extended position;
a retainer secured in the riser;
a flow tube extending through the retainer and configured to move relative to the retainer;
a valve coupled to the riser, the valve closing the inlet when the riser is in the retracted position;
a flow seat movably mounted to the valve such that an axial position of the flow seat relative to the flow tube is adjustable, the flow tube movable relative to the flow seat to control fluid flow into the flow tube; and
a biasing member biasing the flow seat toward the flow tube.

20. The irrigation device of claim 19 wherein the valve includes a passage slidably receiving at least a portion of the flow seat.

21. The irrigation device of claim 19 wherein the flow seat includes a head and a shaft extending from the head to the valve.

22. The irrigation device of claim 21 wherein the shaft of the flow seat extends through a passage of the valve, and the shaft comprises a stop to limit axial movement of the flow seat relative to the valve.

23. The irrigation device of claim 19 wherein a spring urges the flow tube from the flow seat to counter fluid pressure downstream of the flow tube,
wherein the flow seat is positioned a distance D_{FS} from the flow tube by the elongated actuator to set a maximum pressure for fluid flowing beyond the flow tube, where D_{FS}=(A*P_{regulation})/k−(L_{SF}−L_{SI}) where A is the downstream area A of the flow tube exposed to the downstream fluid pressure, P_{regulation} is the maximum pressure, k is the spring constant of the spring, L_{SF} is an uncompressed length of the spring, and L_{SI} is an installed length of the spring.

24. The irrigation device of claim 21 wherein the biasing member is a coil spring, and the shaft of the flow seat extends through coils of the coil spring.

25. The irrigation device of claim 21 wherein the shaft of the flow seat extends through a passage of the valve, and further comprises a seal between the shaft and the valve.

26. The irrigation device of claim 19 wherein the biasing member extends between the valve and at least a portion of the flow seat to bias the at least a portion of the flow seat from the valve.

27. The irrigation device of claim 19 wherein the flow seat is movable axially in the riser to set a maximum pressure of the fluid flowing beyond the flow tube.

28. The irrigation device of claim 19 wherein the flow seat includes a connector to releasably attach the flow seat to the valve.

29. The irrigation device of claim 28 wherein the connector includes one or more deflectable arms insertable into an opening of the valve to attach the flow seat to the valve.

30. The irrigation device of claim 19 further comprising a rod to engage a nozzle assembly mounted to the riser, the rod sized to extend from the nozzle assembly to apply a force to the flow seat counter to the biasing member to set the axial position of the flow seat.

31. The irrigation device of claim 30 wherein the rod is movable in the riser such that fluid pressure moves the rod to restrict fluid flow out of the riser when the riser is disconnected from the nozzle assembly.

32. An irrigation device comprising:
a housing having an inlet;
a riser movable relative to the housing between a retracted position and an extended position;
a pressure regulator mounted in the riser, the pressure regulator having a flow tube and a flow seat, the flow tube movable relative to the flow seat to control fluid flow into the flow tube; and
the flow seat movable between at least a first axial position and a second axial position, the first axial position cooperates with the flow tube to provide a first regulation pressure of the pressure regulator, the second axial position cooperates with the flow tube to provide a second regulation pressure, the first axial position being set when a first type of nozzle assembly is attached to the riser, and the second axial position being set when a second type of nozzle assembly is attached to the riser.

33. The irrigation device of claim 32 wherein attachment of the second type of nozzle assembly to the riser causes the flow seat to move to the second axial position.

34. The irrigation device of claim 32 wherein an elongated actuator of the pressure regulator engages a nozzle assembly attached to the riser to set at least the first regulation pressure or the second regulation pressure, the second type of nozzle assembly extending further into the riser than the first type of nozzle assembly when attached to the riser to cause to position the flow seat at the second axial position.

35. The irrigation device of claim 32 wherein the pressure regulator includes an elongated actuator sized to extend through the flow tube to apply force from the second type of nozzle assembly to the flow seat to position the flow seat in the second axial position.

36. The irrigation device of claim 32 wherein the first regulation pressure is 30-psi and the second regulation pressure is 45-psi.

37. The irrigation device of claim 32 wherein the flow seat is further from a resting position of the flow tube in the second axial position than in the first axial position.

38. The irrigation device of claim 32 wherein the pressure regulator further includes a biasing member urging the flow seat toward the flow tube.

39. The irrigation device of claim 32 further comprising a valve mounted to the riser, the valve closing the inlet when the riser is in the retracted position, and the flow seat is mounted to the valve.

40. The irrigation device of claim 39 wherein the flow seat includes a shaft and a head, the shaft supporting the head from the valve.

41. The irrigation device of claim 32 wherein the second type of nozzle assembly includes a rotary nozzle and the first type of nozzle assembly includes a spray nozzle.

42. A method of setting a regulation pressure of a sprinkler, the method comprising:
inserting a portion of a nozzle assembly into a riser of the sprinkler; and
securing the nozzle assembly to the riser to set an axial position of a flow seat of a pressure regulator of the sprinkler based on an extent that the portion of the nozzle assembly extends into the riser.

43. The method of claim 42 wherein securing the nozzle assembly to the riser includes threading the nozzle assembly to the riser which causes the portion of the nozzle assembly to engage the pressure regulator to adjust the axial position of the flow seat.

44. The method of claim 43 wherein the portion of the nozzle assembly contacts a rod of the pressure regulator that extends between the nozzle assembly and the flow seat.
